(19) United States
(12) Patent Application Publication
(10) Pub. No.: US 2016/0188948 A1
(43) Pub. Date: Jun. 30, 2016

(54) Sensing method and circuit of fingerprint sensor

(71) Applicant: ELAN MICROELECTRONICS CORPORATION, Hsinchu (TW)

(72) Inventor: Chao-Chi Yang, Hsinchu City (TW)

(73) Assignee: ELAN MICROELECTRONICS CORPORATION, Hsinchu (TW)

(21) Appl. No.: 14/975,367

(22) Filed: Dec. 18, 2015

Related U.S. Application Data
(60) Provisional application No. 62/096,894, filed on Dec. 26, 2014.

(30) Foreign Application Priority Data
Nov. 23, 2015 (TW) 104138843

(51) Int. Cl. G06K 9/00

(52) U.S. Cl. CPC G06K 9/0002; G06K 9/00053

(57) ABSTRACT

A sensing method and circuit of fingerprint sensor is disclosed and the sensing method has steps of (a) in the first phase, supplying a first voltage to the electrode plate to be measured and a conductor adjacent to the electrode plate to be measured and setting a voltage of a sensing capacitor, wherein the sensing capacitor is coupled between a first input and an output terminal of the operational amplifier and the electrode plate to be measured disconnects to the first input terminal of the operation amplifier; and (b) in the second phase, stopping to supply the first voltage to the electrode plate to be measured and the conductor, supplying a second voltage to the conductor and a second input terminal of the operational amplifier, and connecting the electrode plate to be measured to the first input terminal to change the voltage of the sensing capacitor.

### CROSS-REFERENCE TO RELATED APPLICATIONS

This application claims the benefit of United States provisional application filed on Dec. 26, 2014 and having application Ser. No. 62/096,894, the entire contents of which are hereby incorporated herein by reference.

This application is based upon and claims priority under 35 U.S.C. 119 from Taiwan Patent Application No. 104138843 filed on Nov. 23, 2015, which is hereby specifically incorporated herein by this reference thereto.

### BACKGROUND OF THE INVENTION

1. Field of the Invention

The present invention relates to a fingerprint sensor, especially to a sensing method and circuit of a fingerprint sensor.

2. Description of the Prior Arts

A conventional projected capacitive fingerprint sensing circuit detects a plate capacitor formed between an electrode plate and a finger. With reference to FIG. 11, four plate capacitors are respectively formed between the four electrode plates PA˜PD and the finger F. A sensing circuit 50 detects the four plate capacitors and respectively outputs four voltage signals V_{OA}˜V_{OD}. These voltage signals V_{OA}˜V_{OD} are used to identify a fingerprint of the finger F located above the electrode plates PA˜PD.

The sensing circuit 50 is coupled to the four electrode plates PA˜PD. Multiple fringe capacitors are formed among the electrode plates PA˜PD. Since the fringe capacitor and the plate capacitor change in opposite ways in response to depth variations of fingerprints, the outputted voltage signal is decreased when detecting the plate capacitor. It is necessary to further improve the drawback accordingly.

### SUMMARY OF THE INVENTION

Based on the aforementioned drawback of the prior art, an objective of the present invention is to provide a sensing method and circuit of a fingerprint sensor to improve an influence to a detection of an electrode plate to be measured, wherein the influence is caused by a fringe capacitor formed between the electrode plate to be measured and another conductor.

To achieve the aforementioned objective, the present invention provides the sensing method of the fingerprint sensor and the sensing method has:

(a) in a first phase, supplying a first voltage to an electrode plate to be measured and a conductor adjacent to the electrode plate to be measured, and setting a voltage of a sensing capacitor, wherein the sensing capacitor is coupled between a first input terminal and an output terminal of an operational amplifier, and the electrode plate to be measured is disconnected to the first input terminal of the operation amplifier; and

(b) in the second phase, stopping supplying the first voltage to the electrode plate to be measured and the conductor, supplying a second voltage to the conductor and a second input terminal of the operational amplifier, and connecting the electrode plate to be measured to the first input terminal to change the voltage of the sensing capacitor.

To achieve the aforementioned another objective, the present invention provides the sensing circuit of the fingerprint sensor having:

a first operational amplifier having a first input terminal, a second input terminal and a first output terminal;

a first sensing capacitor coupled between the first input terminal and the first output terminal of the first operation al amplifier;

a first switching unit having a first terminal connected to an electrode plate to be measured and a second terminal connected to the first voltage;

a second switching unit coupled to the electrode plate to be measured and the first input terminal of the first operational amplifier;

a third switching unit coupled to the first input terminal and the first output terminal of the first operational amplifier;

a fourth switching unit having a first terminal connected to a conductor and a second terminal connected to the first voltage; and

a fifth switching unit having a first terminal connected to the conductor and a second terminal connected to the second voltage; wherein,

in a first phase, the second and fifth switching units are turned off, the first switching unit is turned on to connect the electrode plate to be measured to the first voltage, the fourth switching unit is turned on to connect the conductor to the first voltage, and the third switching unit is turned on; and

in a second phase, the first, third and fourth switching units are turned off and the fifth switching unit is turned on to connect the second input terminal of the first operational amplifier and the conductor to the second voltage, and the second switching unit is turned on to connect the electrode plate to be measured to the first input terminal of the first operational amplifier.

The foregoing sensing method and circuit of the fingerprint sensor of the present invention respectively couple all or a part of the conductors to different voltages in the first and second phases except the electrode plate to be measured to eliminate an influence caused by the fringe capacitor.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of partial structure of a first embodiment of a fingerprint sensor in accordance with the present invention;

FIG. 2 is a circuit diagram of a sensing circuit of FIG. 1;

FIGS. 3A and 3B are two different circuit diagrams of the sensing circuit of FIG. 2 respective in first and second phases;

FIG. 3C is a waveform diagram showing a status of each switching unit and a voltage-variation of each node in the first phase of FIG. 3A and the second phase of FIG. 3B;

FIG. 4 is a sectional schematic view of a partial structure of a second embodiment of a fingerprint sensor in accordance with the present invention;

FIGS. 5A and 5B are two different circuit diagrams of the sensing circuit of FIG. 4 respective in first and second phases;

FIG. 5C is a waveform diagram showing a status of each switching unit and a voltage-variation of each node in the first phase of FIG. 5A and the second phase of FIG. 5B;

FIG. 6 is a schematic view of an electrostatic protection structure of a conventional fingerprint sensor;

FIG. 7 is a circuit diagram of a sensing circuit of FIG. 6;

FIGS. 8A and 8B are two different circuit diagrams of the sensing circuit of FIG. 7 respective in first and second phases;

FIG. 8C is a waveform diagram showing a status of each switching unit and a voltage-variation of each node in the first phase of FIG. 8A and the second phase of FIG. 8B;

FIG. 9A is a schematic view of a partial structure of a third embodiment of a fingerprint sensor in accordance with the present invention;

FIG. 9B is a waveform diagram showing a status of each switching unit and a voltage-variation of each node of FIG. 9A in the first and second phases;

FIG. 10A is a schematic view of a partial structure of a fourth embodiment of a fingerprint sensor in accordance with the present invention;

FIG. 10B is a waveform diagram showing a status of each switching unit and a voltage-variation of each node of FIG. 10A in the first and second phases; and

FIG. 11 is a schematic view of a partial structure of a conventional fingerprint sensor in accordance with the prior art.

### DETAILED DESCRIPTION OF THE EMBODIMENTS

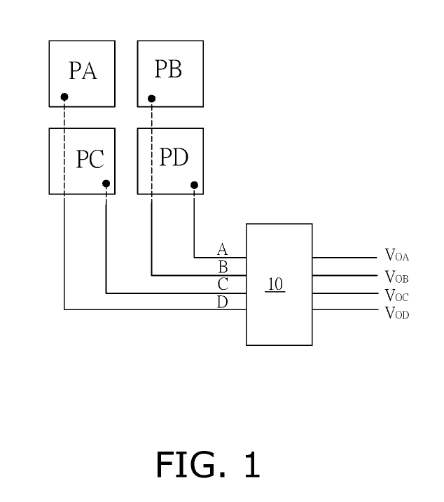

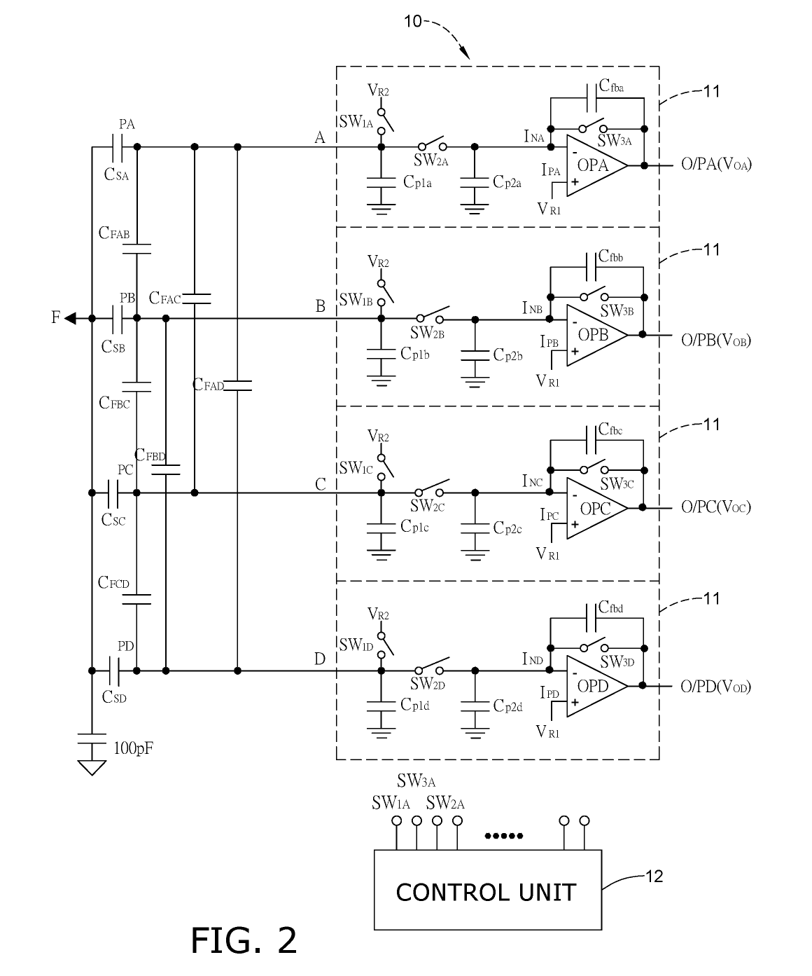

FIG. 1 shows a schematic view of a fingerprint sensor. The fingerprint sensor has multiple electrode plates PA˜PD arranged in a matrix. The electrode plates PA˜PD are connected to a sensing circuit 10. With further reference to FIG. 2, the sensing circuit 10 has multiple detecting units 11. Each of the detecting units 11 has an operational amplifier (OPA, OPB, OPC or OPD), a sensing capacitor (C_{fba}, C_{fbb}, C_{fbc}, or C_{fbd}), a first switching unit (SW_{1A}, SW_{1B}, SW_{1C}, or SW_{1D}), a second switching unit (SW_{2A}, SW_{2B}, SW_{2c}, or SW_{2D}), and a third switching unit (SW_{3A}, SW_{3B}, SW_{3C}, or SW_{3D}). A control unit 12 controls the first to third switching units SW_{1A}˜SW_{1D}, SW_{2A}˜SW_{2D}, SW_{3A}˜SW_{3D}.

With reference to FIG. 2, structures of the detecting units 11 are substantially the same. Using the detecting unit 11 connected to the electrode plate PA as an example, the operational amplifier OPA has an inverting input terminal I_{NA}, a non-inverting input terminal I_{PA} and an output terminal O/PA. The sensing capacitor C_{fba} is coupled between the inverting input terminal I_{NA} and the output terminal O/PA of the operational amplifier OPA. One terminal of the first switching unit SW_{1A} is connected to the electrode plate PA and the other terminal thereof is connected to a first voltage V_{R2}. The second switching unit SW_{2A} is coupled between the electrode plate PA and the inverting input terminal I_{NA} of the operational amplifier OPA. The third switching unit SW_{3A} is coupled between the output terminal O/PA and the inverting input I_{NA} of the operational amplifier OPA. The non-inverting input terminal I_{PA} of the operational amplifier OPA is connected to the second voltage V_{R1}.

Symbols C_{FAB}, C_{FBC}, C_{FCD}, C_{FAC}, C_{FBD}, C_{FAD} represent fringe capacitors which are respectively formed between two corresponding electrode plates. Except for a plate capacitor formed between the electrode plate and the finger and the aforementioned fringe capacitors, other parasitic capacitors corresponding to four nodes A˜D are represented by symbols Cₚ₂ₐ˜C_{p2d}. Other parasitic capacitors corresponding to the inverting input terminals I_{NA}˜I_{ND} D are represented by symbols Cₚ₂ₐ˜C_{p2d}.

In the following description, the measurement of the electrode plate PA (used as an electrode plate to be measured) is used as an example to describe operations of the circuit diagram of FIG. 2.

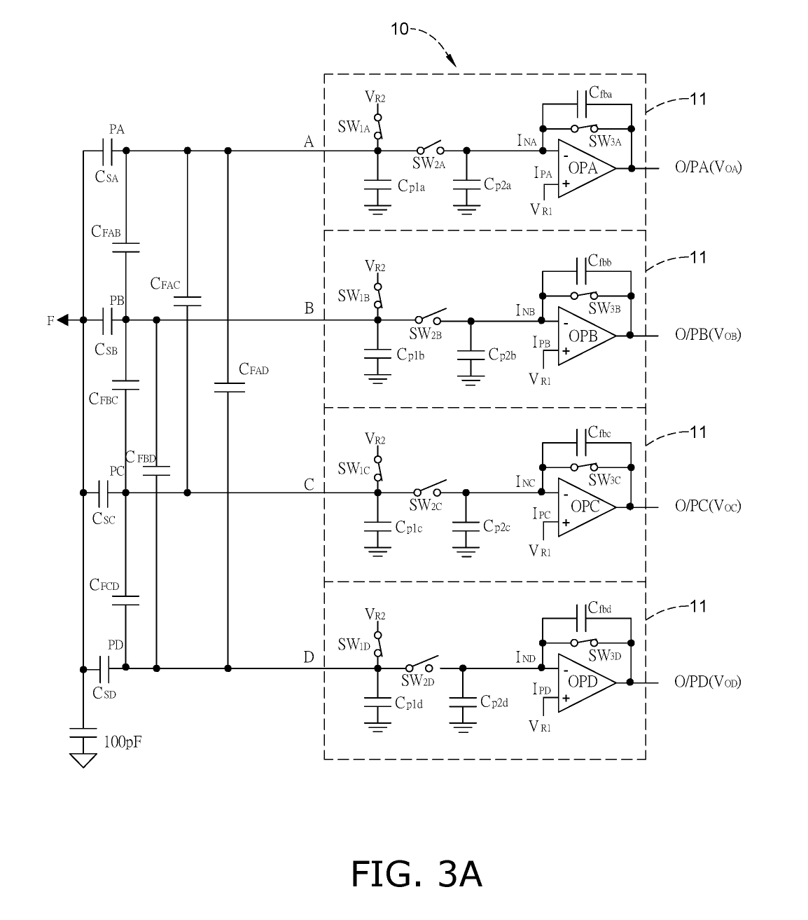

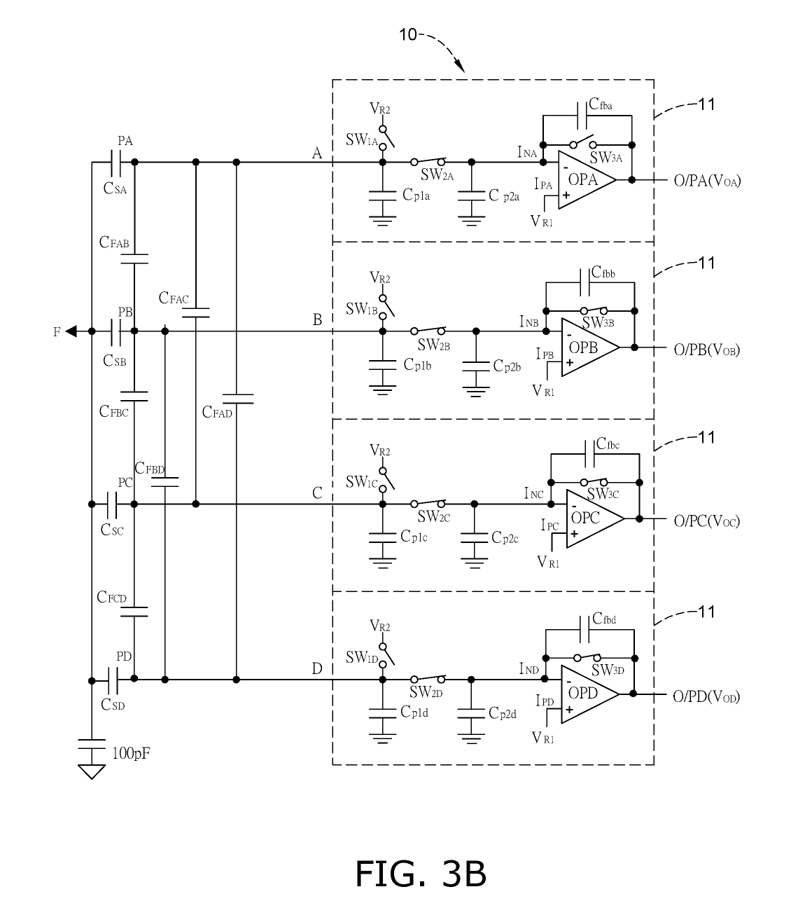

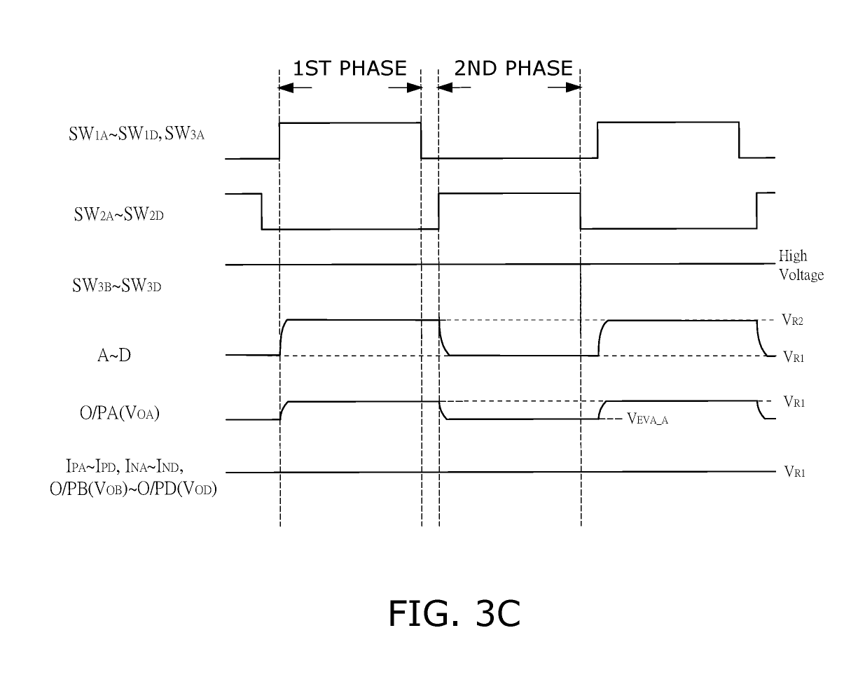

In a first phase (excitation phase or pre-charge phase), with reference to FIG. 3A, all of the second switching units SW_{2A}˜SW_{2D} are turned off. The first switching units SW_{1A}˜SW_{1D} are turned on to couple four first nodes A˜D to the first voltage V_{R2}, that is the electrode plates PA˜PD are connected to the first voltage V_{R2}. All of the third switching units SW_{3A}˜SW_{3D} are turned on. In another embodiment, only the third switching unit SW_{3A} of the detecting unit 11 connected to the electrode plate to be measured PA is turned on in the first phase, so the inverting input terminal I_{NA} is shorted to the output terminal O/PA the operational amplifier OPA, and an electric potential of the sensing capacitor C_{fba} is ideally to be zero at the time. A purpose of turning on the third switching unit SW_{3A} is to set a voltage of the sensing capacitor C_{fba}.

A following operation is shown in FIG. 3B. In a second phase (reading phase or evaluation phase), the non-inverting input terminals IPA˜IPD of the operational amplifiers OPA˜OPD are connected to the second voltage V_{R1}. Only the third switching unit SW_{3A} is turned off. The first switching units SW_{1A}˜SW_{1D} are turned off. The second switching units SW_{2A}˜SW_{2D} are turned on to respectively connect the electrode plates PA˜PD to the corresponding inverting input terminals I_{NA}˜I_{ND} of the operational amplifiers OPA˜OPD. In FIG. 3B, the third switching units SW_{3B}˜SW_{3D} are turned on. In another embodiment, the third switching units SW_{3B}˜SW_{3D} shown in FIG. 3B may be turned off. In the embodiment of FIGS. 3A and 3B, the non-inverting input terminal I_{PA} of the operational amplifier OPA is connected to the second voltage V_{R1}.

In the second phase, the voltage of the sensing capacitor C_{fba} is changed. A capacitance value of the plate capacitor C_{SA} formed between the electrode plate to be measured PA and the finger F can be obtained by reading the voltage signal V_{OA} of the output terminal of the operational amplifier OPA.

In the first phase, the electrode plate PA and other electrode plates PB˜PD around the electrode plate PA are connected to the first voltage V_{R2}. In the second phase, the electrode plates PA˜PD are respectively connected to the corresponding inverting input terminals I_{NA}˜I_{ND} of the operational amplifiers OPA˜OPD. According to a virtual ground characteristic of the operational amplifier, an electric potential of each of the inverting input terminals I_{NA}˜I_{ND} is equal to the second voltage V_{R1}. Therefore, the electrode plate PA and other electrode plates PB˜PD around the electrode plate PA are connected to the second voltage V_{R1}.

After the operations of the first and second phases, the voltage signal V_{OA} read out from the operational amplifier OPA can be represented as an following equation: V_{OA}=V_{R1}−[(V_{R2}−V_{R1})×(C_{SA}/C_{FBA}+Cₚₗₐ/C_{FBA})]. The equation shows that the voltage signal V_{OA} does not include the fringe capacitors, which are respectively formed between the electrode plate PA and other electrode plates PB˜PD. Therefore, the voltage signal V_{OA} is not affected by these fringe capacitors.

In the first phase of FIG. 3A and the second phase of FIG. 3B, a status of each switching unit and a voltage variation of each node in an embodiment are shown in FIG. 3C. In a time sequence of each switching unit, a high voltage level represents that the switching unit is turned on and a low voltage level represents that the switching unit is turned off. In this embodiment, the first voltage V_{R2} is larger than the second voltage V_{R1}. From the first phase to the second phase, the first switching unit SW_{1A}˜SW_{1D} and the third switching unit SW_{3A} are turned off before the second switching unit SW_{2A}˜SW_{2D} are turned on.

In the embodiment of FIGS. 3A and 3B, the electric potential of the inverting input terminal I_{NA} of the operational amplifier OPA is equivalent to the second voltage V_{R1} in the first and second phases. When reading a measurement signal in the second phase, electric charges do not flow into or out from the parasitic capacitance Cₚ₂ₐ of the inverting input terminal I_{NA}. Other structures of fingerprint sensors may be applied to the present invention.

Based on the foregoing description, the present invention can remove an influence caused by the fringe capacitor formed between the electrode plate to be measured PA and a conductor adjacent to the electrode plate to be measured PA. The conductor may be one of the other electrode plates, such as the electrode plates PB˜PD mentioned above, an electrostatic protection electrode, or a noise-shielding electrode. Those electrodes may be arranged in the same layer with the electrode plate to be measured PA, or in the upper layer or lower layer of the electrode plate to be measured PA.

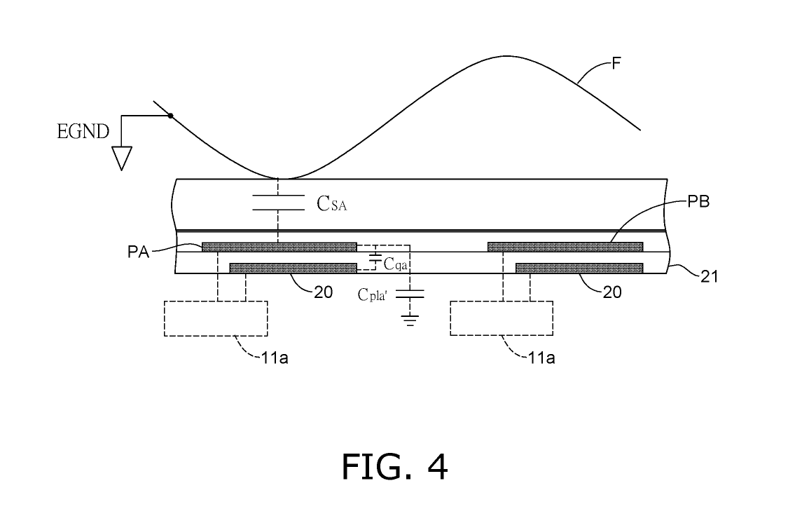

In a second embodiment of FIG. 4, an isolation electrode plate 20 is formed under each of the electrode plates PA and PB to isolate most of the parasitic capacitors among the electrode plates PA and PB and multiple circuit elements below the electrode plates PA and PB. A dielectric layer 21 is formed between the electrode plates PA and PB and the isolation electrode plates 20 thereof. Using the electrode plate to be measured PA as an example, the original parasitic capacitance Cₚₗₐ′ between the electrode plate to be measured PA and the conductor is decreased to a small parasitic capacitance Cₚₗₐ′. A symbol C_{qa} represents a capacitor between the electrode plate to be measured PA and the isolation electrode plate 20.

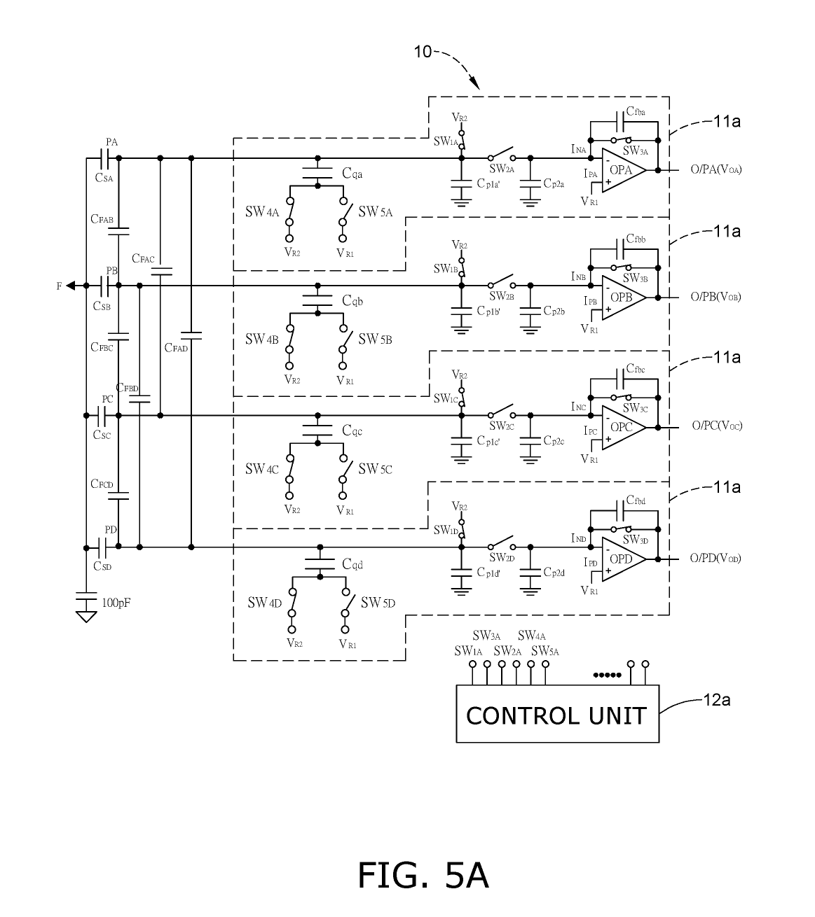

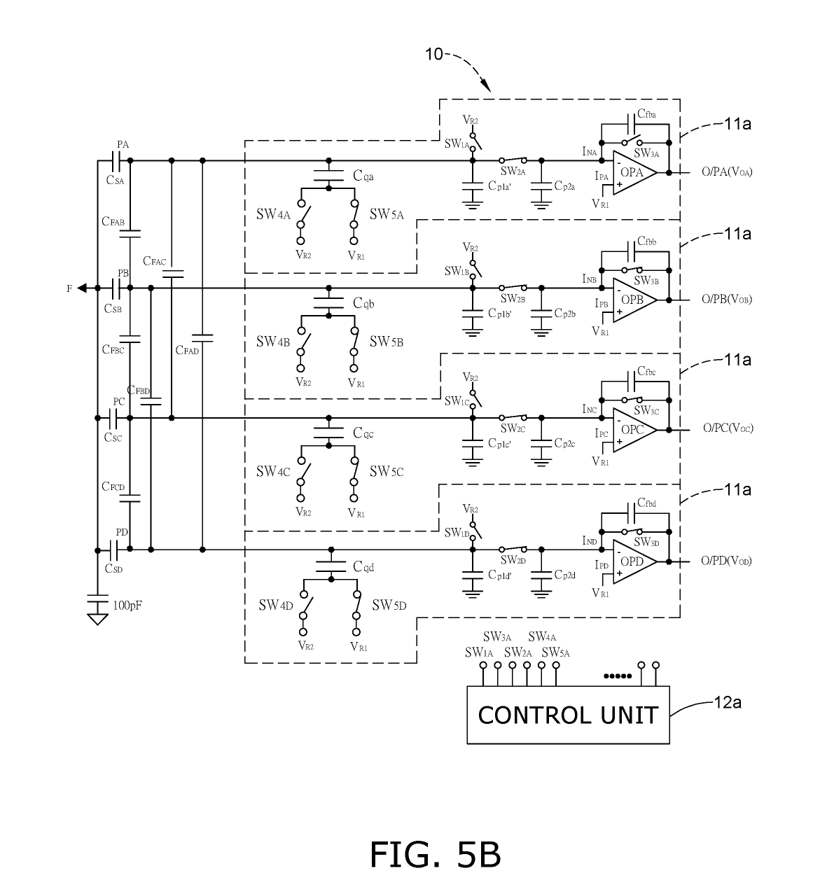

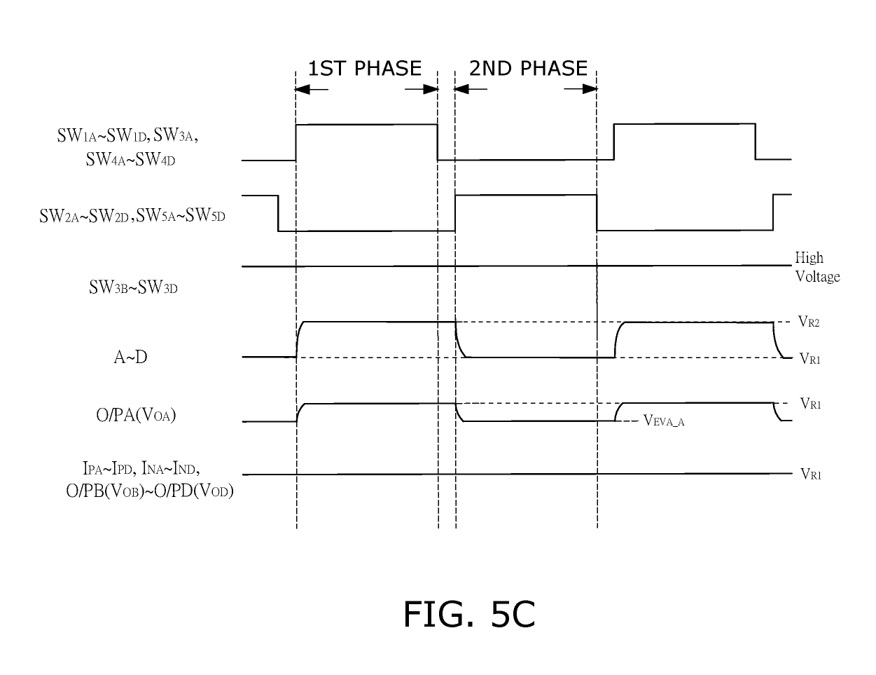

In FIG. 5A, an embodiment of a detecting unit 11a is applied to the structure of FIG. 4. The detecting unit 11a further has a fourth switching unit (SW_{4A}, SW_{4B}, SW_{4C}, or SW_{4D}) and a fifth switching unit (SW_{5A}, SW_{5B}, SW_{5C}, or SW_{5D}) to respectively couple the corresponding isolation electrode plate 20 to the first voltage V_{R2} or the second voltages V_{R1}. In the first phase, the fourth switching units SW_{4A}˜SW_{4D} are turned on and the fifth switching units SW_{5A}˜SW_{5D} are turned off, so that the isolation electrode plates 20 are coupled to the first voltage V_{R2}. In the second phase, with further reference to FIG. 5B, the fourth switching units SW_{4A}˜SW_{4D} are turned off and the fifth switching units SW_{5A}˜SW_{5D} are turned on, so that the isolation electrode plates 20 are coupled to the second voltage V_{R1}. For the statuses of other switching units, please refer to FIGS. 3A and 3B and the related descriptions thereof, so the details are not described below for the sake of brevity.

In the first phase of FIG. 5A and the second phase of FIG. 5B, a status of each switching unit and a voltage variation of each node in an embodiment are shown in FIG. 5C. In a time sequence of each switching unit, a high voltage level represents that the switching unit is turned on and a low voltage level represents that the switching unit is turned off. In this embodiment, the first voltage V_{R2} is larger than the second voltage V_{R1}. From the first phase to the second phase, the first switching unit SW_{1A}˜SW_{1D}, the third switching unit SW_{3A}, and the fourth switching unit SW_{4A}˜SW_{4D} are turned off before the second switching unit SW_{2A}˜SW_{2D} and the fifth switching unit SW_{5A}˜SW_{5D} are turned on.

In the first phase, the first voltage V_{R2} is supplied to the isolation electrode plate 20 and the electrode plate to be measured PA. In the second phase, the isolation electrode plate 20 and the electrode plate to be measured PA are connected to the second voltage V_{R1}, so the electric potentials of the isolation electrode plate 20 and the electrode plate to be measured PA are the same. In such arrangement, the voltage signal V_{OA} is not affected by the capacitor C_{qa} formed between the electrode plate to be measured PA and the isolation electrode plate 20.

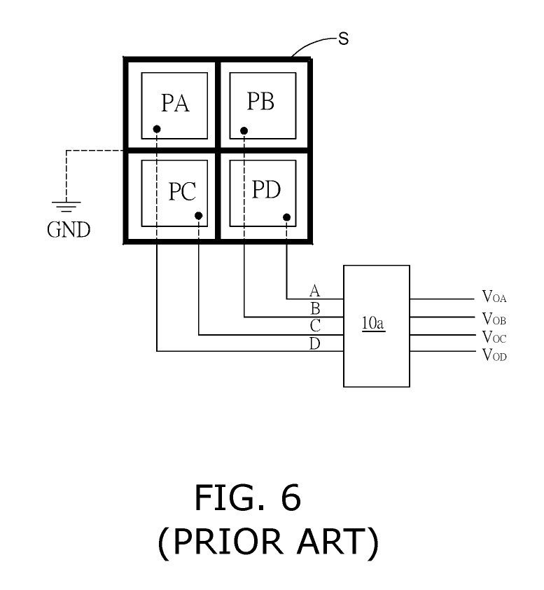

FIG. 6 illustrates an electrostatic protection structure of a conventional fingerprint sensor. The fingerprint sensor has a protection electrode S formed around each of the electrode plates PA˜PD. In any phase, the protection electrode S is connected to a ground to provide an electrostatic protection for the corresponding electrode plate PA, PB, PC or PD. For example, a human static electricity is released to the ground through a discharge path (marked in a dotted line) between the protection electrode S and the ground, so the protection electrode S prevents the corresponding electrode plate PA, PB, PC or PD from damaging. However, a fringe capacitor C_{FAS} formed between the electrode plate to be measured PA and the protection electrode S thereof affects the voltage signal V_{OA} outputted from the sensing circuit 10.

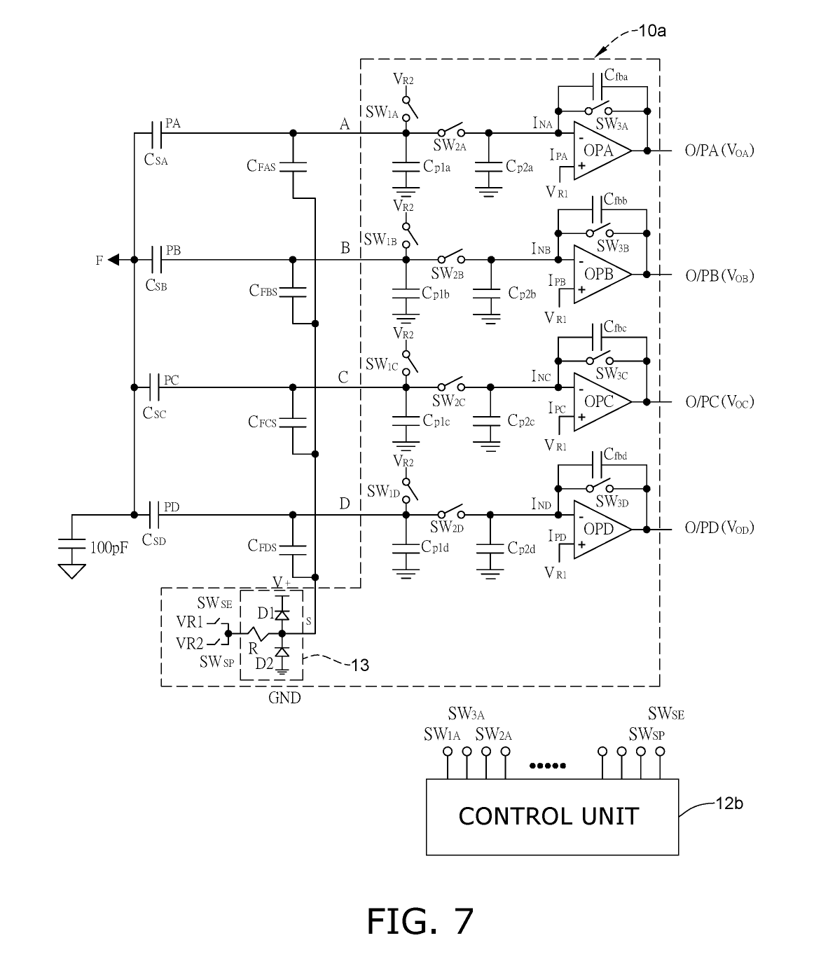

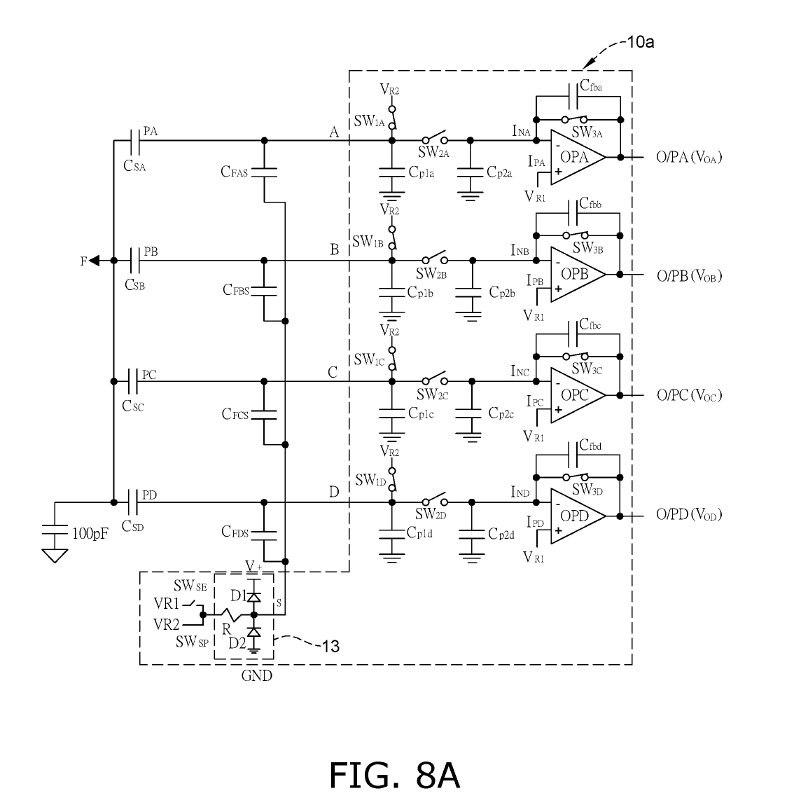

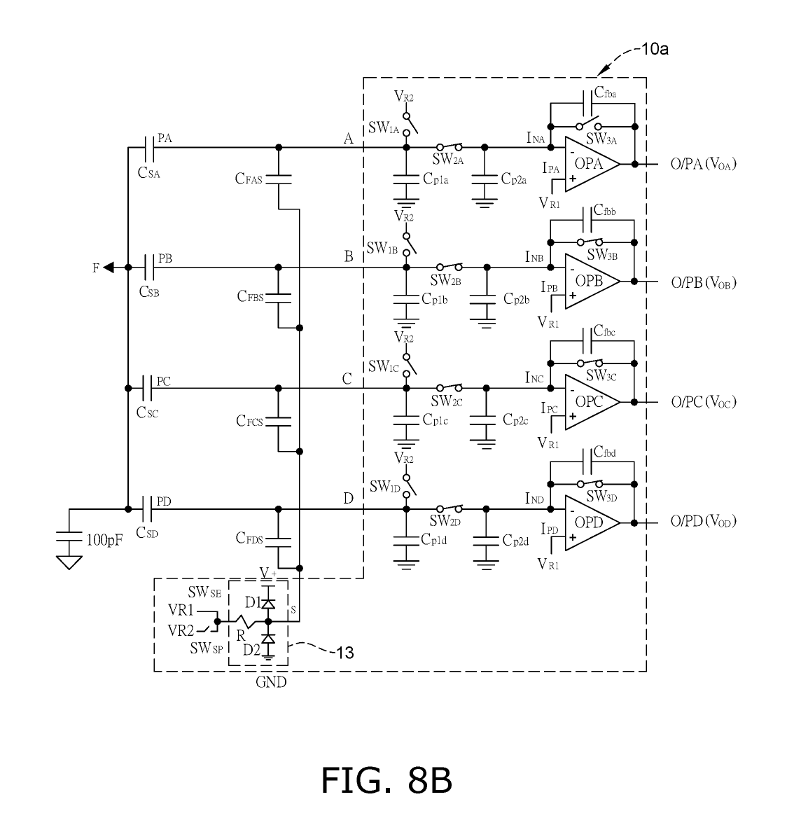

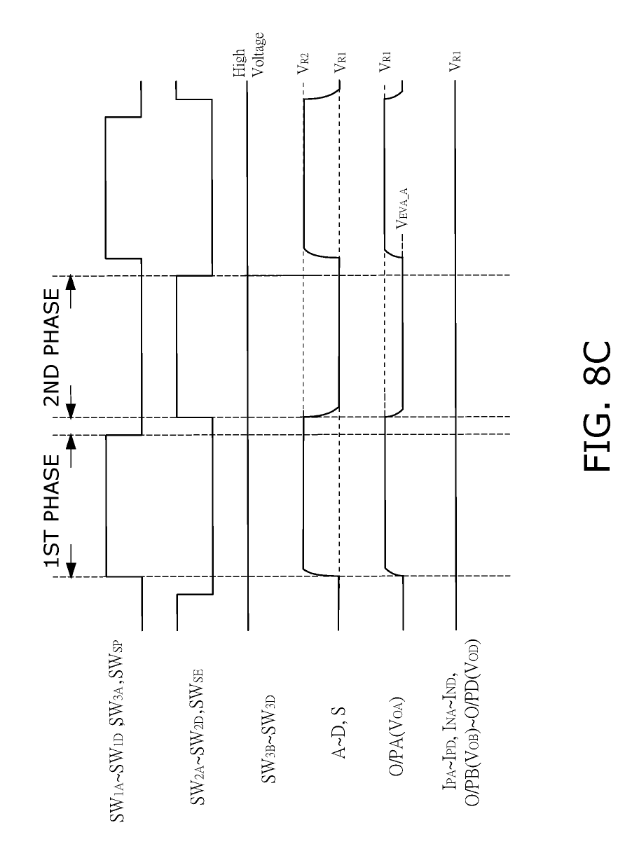

A third embodiment of the sensing circuit 10a of FIG. 7 can improve an influence to a measurement result, wherein the influence is caused by the fringe capacitors C_{FAS} formed between the electrode plate to be measured PA and the protection electrode S. In comparison with FIG. 2, the sensing circuit 10a of FIG. 7 further has an electrostatic protection circuit 13, a sixth switching unit SW_{SP}, and a seventh switching unit SW_{SE}. One terminal of the sixth switching unit SW_{SP} is coupled to the first voltage V_{R2} and the other terminal thereof is coupled to the protection electrode S through the electrostatic protection circuit 13. One terminal of the seventh switching unit SW_{SE} is coupled to the second voltage V_{R1} and the other terminal thereof is coupled to the protection electrode S through the electrostatic protection circuit 13. The sixth and seventh switching units SW_{SP} and SW_{SE} are coupled to a control unit 12b, and the control unit 12b controls the sixth and seventh switching units to turn on or off. In the first phase, with reference to FIG. 8A, the sixth switching unit SW_{SP} is turned on and the seventh switching unit SW_{SE} is turned off, so the protection electrode S is coupled to the first voltage V_{R2}.

In the second phase, with reference to FIG. 8B, the sixth switching unit SW_{SP} is turned off and the seventh switching unit SW_{SE} is turned on, so the protection electrode S is coupled to the second voltage V_{R1}.

In the first phase, the protection electrode S and the electrode plate to be measured PA are supplied with the first voltage V_{R2} so the electric potentials of the protection electrode S and the electrode plate PA are the same. In the second phase, the protection electrode S and the electrode plate to be measured PA are supplied with the second voltage V_{R1} so the electric potentials of the protection electrode S and the electrode plate PA are the same. In such arrangement, the voltage signal V_{OA} is not affected by the fringe capacitors C_{FAS} formed between the electrode plate to be measured PA and the protection electrode S.

In the first phase of FIG. 8A and the second phase of FIG. 8B, a status of each switching unit and a voltage variation of each node in an embodiment are shown in FIG. 8C. In a time sequence of each switching unit, a high voltage level represents that the switching unit is turned on and a low voltage level represents that the switching unit is turned off. In this embodiment, the first voltage V_{R2} is larger than the second voltage V_{R1}. From the first phase to the second phase, the first switching unit SW_{1A}˜SW_{1D}, the third switching unit SW_{3A}, and the sixth switching unit SW_{SP} are turned off before the second switching unit SW_{2A}˜SW_{2D} and the seventh switching unit SW_{SE} are turned on.

In the present embodiment, the electrostatic protection circuit 13 has a first diode D1, a second diode D2 and a resistor element R. An anode of the first diode D1 is connected to the protection electrode S, and a cathode of the first diode D1 is connected to a high and positive voltage V+, such as an operation voltage Vdd. A cathode of the second diode D2 is connected to the anode of the first diode D1 and the protection electrode S, and an anode of the second diode D2 is connected to the ground GND. One terminal of the resistor R is connected to the protection electrode S and the other terminal thereof is connected to the sixth and seventh switching units SW_{SP} and SW_{SE}. Two discharging paths are respectively formed from the protection electrode S to the high and positive electric potential V+ and from the protection electrode S to the ground GND. An impedance of each discharging path is smaller than that of the resistor element R. The positive electrostatic charges will move to the high and positive voltage V+ through the first diode D1, and the negative electrostatic charges will move to the ground GND through the second diode D2. Accordingly, the positive and negative electrostatic charges do not affect the first voltage V_{R2} or the second voltage V_{R1}.

Based on the foregoing description, the four electrode plates PA˜PD are used as an example and the present invention can be applied to a real fingerprint sensor having more than four electrode plates PA˜PD. In aforementioned embodiments, detecting electrode plate PA is used as an example to describe the features of the present invention, but in another embodiment, detecting multiple electrode plates at the same time is possible, and sensing signals of the multiple electrode plates can be read out at the same time. The first to third embodiments can be implemented individually or combined to each other. That is, the potential of the electrode plate to be measured, the electrode plates adjacent to the electrode plate to be measured, the protection electrode and the isolation electrode plate can be switched to different electric potentials at the same time according to the present invention.

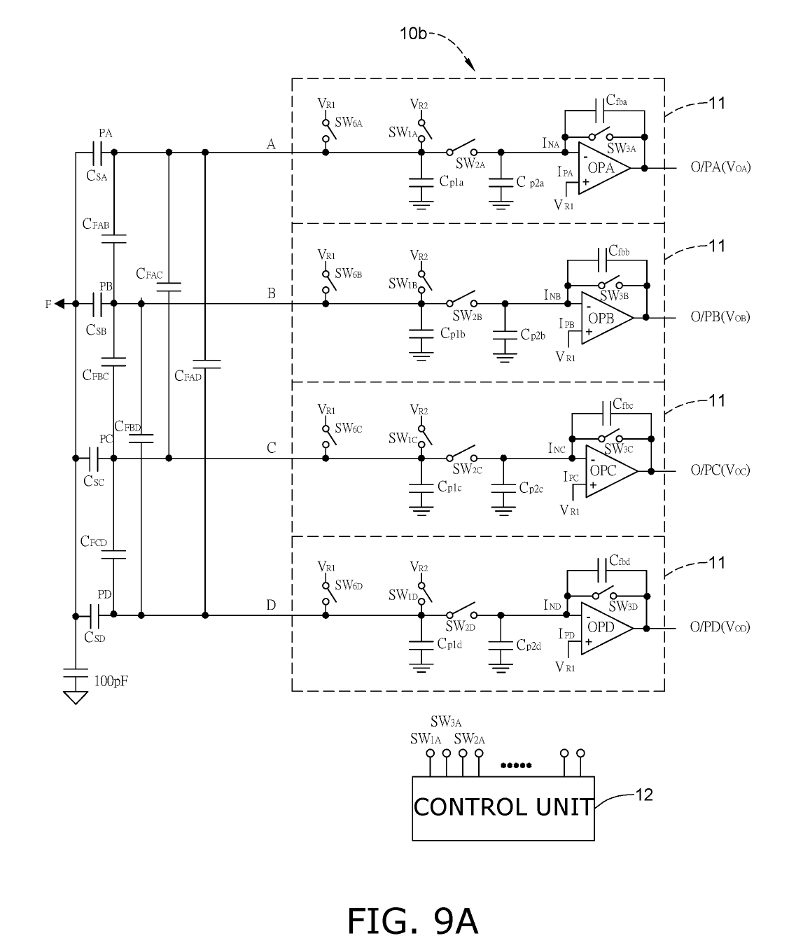

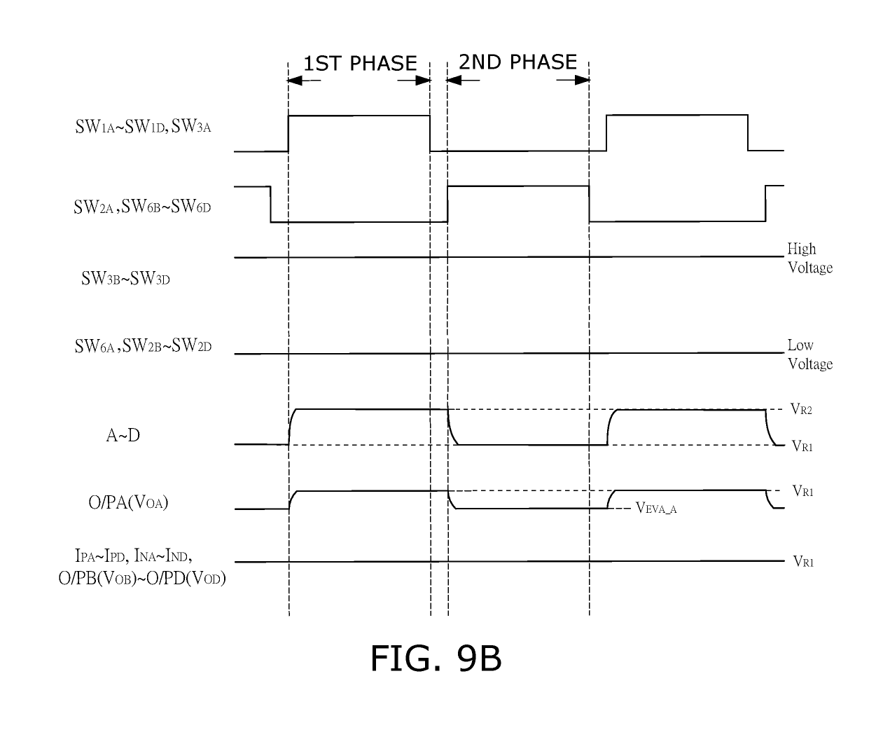

FIG. 9A shows a fourth embodiment of the sensing circuit 10b, which is similar to the first embodiment of FIG. 2. The fourth embodiment further has eighth switching units SW_{6A}˜SW_{6D} in the detecting unit 11 One terminal of each of the eighth switching units SW_{6A}, SW_{6B}, SW_{6c}, or SW_{6D} is connected to the corresponding electrode plates PA, PB, PC or PD, and other terminal is connected to the second voltage V_{R1}.

An operation in the first phase of the fourth embodiment is the same as that of the first embodiment, and all of the eighth switching units SW_{6A}˜SW_{6D} are turned off in the first phase.

In the second phase of the fourth embodiment, all of the first switching units SW_{1A}˜SW_{1D} and the third switching unit SW_{3A} are turned off, the second switching unit SW_{2A} is turned on, and the eighth switching units SW_{6B}˜SW_{6D} connected to the electrode plates PB˜PD are turned on. According to the virtual ground characteristic of the operational amplifier, an electric potential of the inverting input terminal I_{NA} of the operational amplifier OPA connected to the electrode plate to be measured PA is equal to the second voltage V_{R1}. Accordingly, the electrode plate to be measured PA and the electrode plates PB˜PD are coupled to the second voltage V_{R1}. Comparing with FIG. 2, the statuses of the second and third switching units SW_{2B}˜SW_{2D} and SW_{3B}˜SW_{3D} of the detecting units 11 respectively connected to the electrode plates PB˜PD are the same as statuses thereof in the first phase, and thereby the second and third switching units SW_{2B}˜SW_{2D} and SW_{3B}˜SW_{3D} of the detecting units 11 are not switched. The electrode plates PB˜PD can be coupled to the second voltage V_{R1} by turning on the eighth switching units SW_{6B}˜SW_{6D} only.

In the first and second phases, a status of each switching unit of FIG. 9A and a voltage variation of each node of FIG. 9A in an embodiment are shown in FIG. 9B. In a time sequence of each switching unit, a high voltage level represents that the switching unit is turned on and a low voltage level represents that the switching unit is turned off. In this embodiment, the first voltage V_{R2} is larger than the second voltage V_{R1}. From the first phase to the second phase, the first switching unit SW_{1A}˜SW_{1D} and the third switching unit SW_{3A} are turned off before the second switching unit SW_{2A} and the eighth switching unit SW_{6B}˜SW_{6D} are turned on.

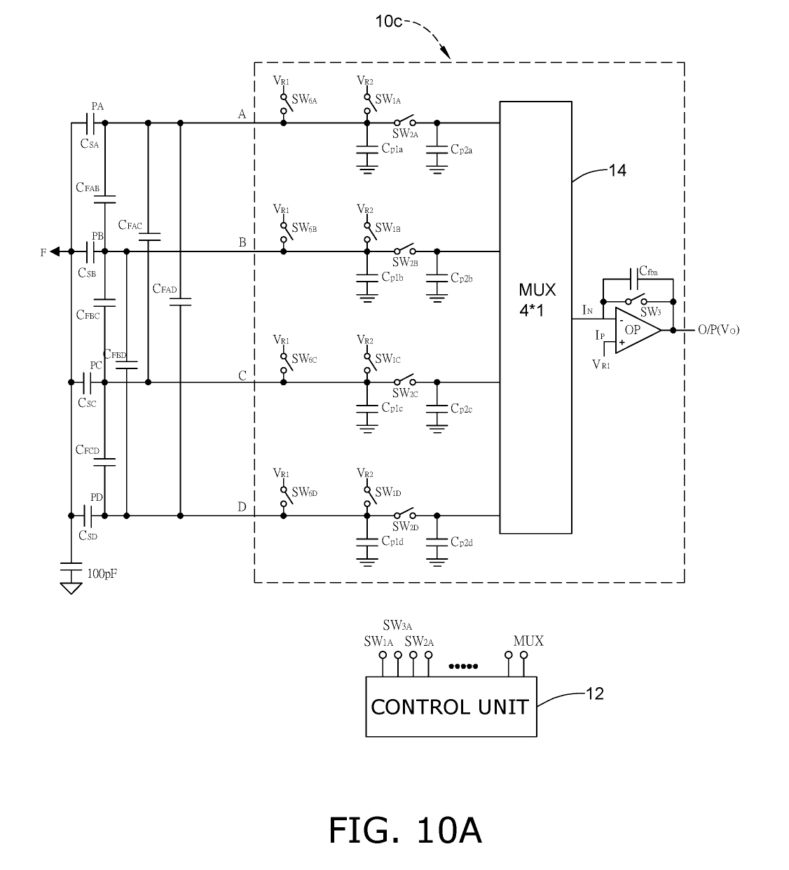

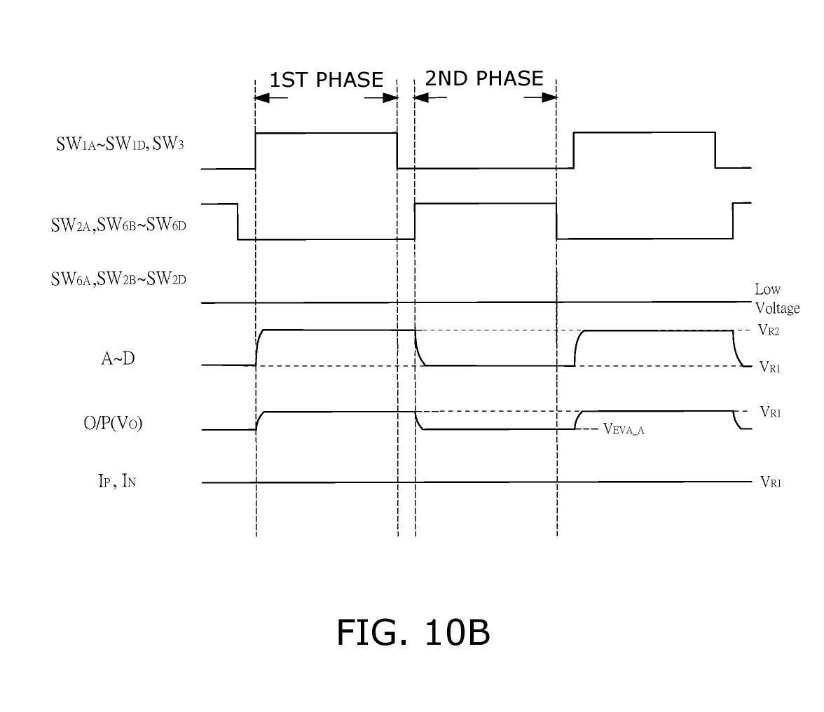

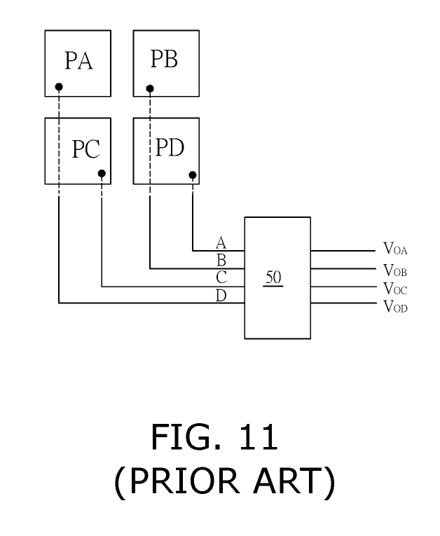

FIG. 10A shows a fifth embodiment of the sensing circuit 10c, which is similar to the fourth embodiment of FIG. 9A and a difference is that the second switching units SW_{2A}˜SW_{2D} is connected to an operational amplifier OP through a multiplexer 14. When detecting the electrode plate PA, the control unit 12 controls the multiplexer 14 to connect an inverting input terminal I_{N} of the operational amplifier to the second switching units SW_{2A}.

In the first phase, all of the first switching units SW_{1A}˜SW_{1D} are turned on, all of the second switching units SW_{2A}˜SW_{2D} are turned off. Since the fifth embodiment has only one operational amplifier OP, the third switching units SW₃ connected to the operational amplifier OP is turned on.

In the second phase, all of the first switching units SW_{1A}˜SW_{1D} are turned off, the third switching units SW₃ of the operational amplifier is turned off, the second switching switch SW_{2A} connected to the electrode plate PA is turned on, and the eighth switching units SW_{6B}˜SW_{6D} connected to the electrode plates PB˜PD are turned on.

With comparison with FIG. 9A, the fifth embodiment does not require to switch the second switching units SW_{2B}˜SW_{2D} connected to the electrode plates PB˜PD in the second phase and does not require operational amplifiers OPB˜OPD since the multiplexer 14 is employed.

In the first and second phases, a status of each switching unit of FIG. 10A and a voltage variation of each node of FIG. 10A in an embodiment are shown in FIG. 10B. In a time sequence of each switching unit, a high voltage level represents that the switching unit is turned on and a low voltage level represents that the switching unit is turned off. In this embodiment, the first voltage V_{R2} is larger than the second voltage V_{R1}. From the first phase to the second phase, the first switching unit SW_{1A}˜SW_{1D} and the third switching unit SW₃ are turned off before the second switching unit SW_{2A} and the eighth switching unit SW_{6B}˜SW_{6D} are turned on.

Based on the foregoing description, a sensing method of the fingerprint sensor as described has steps of: (a) in a first phase, supplying a first voltage to an electrode plate to be measured and a conductor adjacent to the electrode plate to be measured, and setting a voltage of a sensing capacitor, wherein the sensing capacitor is coupled between a first input terminal and an output terminal of an operational amplifier, and the electrode plate to be measured is disconnected to the first input terminal of the operation amplifier; and (b) in the second phase, stopping supplying the first voltage to the electrode plate to be measured and the conductor, supplying a second voltage to the conductor and a second input terminal of the operational amplifier, and connecting the electrode plate to be measured to the first input terminal to change the voltage of the sensing capacitor. The second phase can be realized as the reading phase to read out an output signal from the output terminal of the operational amplifier and to retrieve a sensing result of the electrode plate to be measured.

It is possible to combine aforementioned embodiments. For example, the embodiment of the fingerprint sensor having an protection electrode and/or isolation electrode plate may use the aforementioned operations of each embodiment to prevent that the measurement result is affected by the capacitor formed between the electrode plate to be measured and the adjacent conductor (such as the protection electrode or the isolation electrode plate).

According to the sensing circuit of the fingerprint sensor provided by the present invention, the sensing circuit is used to detect one of electrode plate to be measured of the fingerprint sensor and has: a first operational amplifier having a first input terminal, a second input terminal and a first output terminal; a first sensing capacitor coupled between the first input terminal and the first output terminal of the first operational amplifier; a first switching unit having a first terminal connected to an electrode plate to be measured and a second terminal connected to the first voltage; a second switching unit coupled between the electrode plate to be measured and the first input terminal of the first operational amplifier; a third switching unit coupled between the first input terminal and the first output terminal of the first operational amplifier; a fourth switching unit having a first terminal connected to a conductor and a second terminal connected to the first voltage; and a fifth switching unit having a first terminal connected to the conductor and a second terminal connected to the second voltage; wherein, in a first phase, the second and fifth switching units are turned off and the first switching unit is turned on to connect the electrode plate to be measured to the first voltage, and the fourth switching unit is turned on to connect the conductor to the first voltage and the third switching unit is turned on, in a second phase, the first, third and fourth switching units are turned off and the fifth switching unit is turned on to connect the second input terminal of the first operational amplifier and the conductor to the second voltage, and the second switching unit is turned on to connect the electrode plate to be measured to the first input terminal of the first operational amplifier.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A sensing method of the fingerprint sensor to sense an electrode plate to be measured of the fingerprint sensor comprising steps of:
(a) in a first phase, supplying a first voltage to the electrode plate to be measured and a conductor adjacent to the electrode plate to be measured, and setting a voltage of a sensing capacitor, wherein the sensing capacitor is coupled between a first input and an output terminal of the operational amplifier and the electrode plate to be measured disconnects to the first input terminal of the operation amplifier; and
(b) in a second phase, stopping to supply the first voltage to the electrode plate to be measured and the conductor, supplying a second voltage to the conductor and a second input terminal of the operational amplifier, and connecting the electrode plate to be measured to the first input terminal to change the voltage of the sensing capacitor.

2. The sensing method as claimed in claim 1, wherein the conductor is a first electrode plate adjacent to the electrode plate to be measured, and the first electrode plate is used to sense a fingerprint.

3. The sensing method as claimed in claim 1, wherein the conductor is a protection electrode, and the protection electrode provides an electrostatic discharge protection.

4. The sensing method as claimed in claim 1, wherein
in the step (a), the first voltage is further supplied to an isolation electrode plate, which is formed under the electrode plate to be measured; and
in the step (b), the first voltage is not supplied, and the second voltage is further supplied to the isolation electrode plate.

5. A sensing circuit of a fingerprint sensor to sense an electrode plate to be measured of the fingerprint sensor comprising:
a first operational amplifier having a first input terminal, a second input terminal and a first output terminal;
a first sensing capacitor coupled between the first input terminal and the first output terminal of the first operational amplifier;
a first switching unit having a first terminal connected to the electrode plate to be measured and a second terminal connected to the first voltage;
a second switching unit coupled between the electrode plate to be measured and the first input terminal of the first operational amplifier;
a third switching unit coupled between the first input terminal and the first output terminal of the first operational amplifier;
a fourth switching unit having a first terminal connected to a conductor and a second terminal connected to the first voltage; and
a fifth switching unit having a first terminal connected to the conductor and a second terminal connected to the second voltage; wherein,
in a first phase, the second and fifth switching units are turned off, the first switching unit is turned on to connect the electrode plate to be measured to the first voltage, the fourth switching unit is turned on to connect the conductor to the first voltage, and the third switching unit is turned on; and
in a second phase, the first, third and fourth switching units are turned off and the fifth switching unit is turned on to connect the second input terminal of the first operational amplifier and the conductor to the second voltage, and the second switching unit is turned on to connect the electrode plate to be measured to the first input terminal of the first operational amplifier.

6. The sensing circuit as claimed in claim 5, wherein the conductor is a first electrode plate adjacent to the electrode plate to be measured and the first electrode plate is used to sense a fingerprint.

7. The sensing circuit as claimed in claim 6, further comprising:
a second operational amplifier having a third input terminal, a fourth input terminal and a second output terminal; wherein the fourth input terminal is coupled to the second voltage;
a second sensing capacitor coupled between the third input terminal and the second output terminal of the second operational amplifier; and
a sixth switching unit coupled between the first electrode plate and the third input terminal of the second operational amplifier, turned off in the first phase, and turned on in the second phase.

8. The sensing circuit as claimed in claim 5, further comprising:
a seventh switching unit coupled between an isolation electrode plate formed under the electrode plate to be measured and the first voltage; and
an eighth switching unit coupled between the isolation electrode plate and the second voltage; wherein,
in the first phase, the seventh switching unit is turned on and the eighth switching unit is turned off to supply the first voltage to the isolation electrode plate; and
in the second phase, the seventh switching unit is turned off and the eighth switching unit is turned on to stop supplying the first voltage to the isolation electrode plate and to supply the second voltage to the isolation electrode plate.

9. The sensing circuit as claimed in claim 5, wherein the conductor is a protection electrode, and the protection electrode provides an electrostatic discharge protection.

10. The sensing circuit as claimed in claim 9, further comprising an electrostatic protection circuit coupled between the protection electrode and the fourth and fifth switching units.

11. The sensing circuit as claimed in claim 10, wherein the electrostatic protection circuit comprises:
a first diode having an anode connected to the protection electrode and a cathode connected to a high voltage terminal;
a second diode having a cathode connected to the anode of the first diode and the protection electrode, and an anode connected to a ground; and
a resistor element having a first terminal connected to a node which the first and second diodes are commonly connected, and a second terminal connected to the fourth and fifth switching units.

12. The sensing circuit as claimed in claim 6, further comprising:
a multiplexer coupled between the second switching unit and the first input terminal of the first operational amplifier; and
a sixth switching unit coupled between the first electrode plate and the multiplexer, and turned off in the first phase and turned on in the second phase.

13. The sensing circuit as claimed in claim 7, further comprising a ninth switching unit having:
a first terminal connected to the first electrode plate; and
a second terminal connected to the second voltage, wherein the ninth switch is turned off in the first phase and is turned on in the second phase.

14. The sensing circuit as claimed in claim 12, further comprising a ninth switching unit having:
a first terminal connected to the first electrode plate; and
a second terminal connected to the second voltage, wherein the ninth switch is turned off in the first phase and is turned on in the second phase.
